(19) United States
(12) Patent Application Publication
(10) Pub. No.: US 2004/0070794 A1
(43) Pub. Date: Apr. 15, 2004

(54) Scanning method capable of reducing the scanning period

(76) Inventor: Shih-Zheng Kuo, Taipei (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/662,859

(22) Filed: Sep. 15, 2003

(30) Foreign Application Priority Data
Oct. 14, 2002 (TW) 091123621

(51) Int. Cl. H04N 1/393; H04N 1/04

(52) U.S. Cl. 358/451; 358/474

(57) ABSTRACT

A scanning method that is able to reduce the scanning period. According to the width of the document to be scanned, a front pixel region, an effective pixel region for actually fetching the image of the document to be scanned, and a post pixel region are set for the optical sensing device. The induced charges belonging to the front pixel region and the induced charges belonging to the effective pixel region with respect to each one of the scanning lines are sequentially fetched out. The induced charges belonging to the post pixel region with respect to each one of the scanning lines are transferred to the front pixel region, so as to be added into the induced charges belonging to the front pixel region for the next scanning line with respect to the scanning lines. The induced charges belonging to the effective pixel region with respect to the each one of the scanning lines are processed into a piece of the image. And then, the pieces of the image are collected to form a full image with respect to the document to be scanned.

This application claims the benefit of Taiwan application Serial No. 091123621, filed Oct. 14, 2002.

### BACKGROUND OF THE INVENTION

1. Field of the Invention

This present invention relates to a scanning method, and more particularly, the present invention relates to a scanning method, which can reduce the time consumption on fetching out and processing on the induced charges of an optical sensing device.

2. Description of Related Art

A scanner typically includes at least a chassis member, a light source, and a scanning platform, in which the chassis member further includes a reflection mirror, a lens, and an optical sensing device. The scanning platform is used to dispose a document to be scanned thereon. The optical source is disposed on the chassis member, so as to provide the light beam that is needed in scanning operation. The chassis member is moved in a manner of step by step, so as to scan the document to be scanned and fetch the image of the document to be scanned. When the chassis member scans the document to be scanned step by step, the light source provides the light beam, which illuminates the document to be scanned, and then the reflection mirror reflect the light beam, which is reflected from the document to be scanned, onto the lens. The lens then collects the light beam and focuses the light beam to form an image on the optical sensing device. And then, a light exposure action is activated on the optical sensing device, so as to fetch the image of the document to be scanned. Wherein, the optical sensing device can be an optical charge coupled device (CCD).

Referring to FIG. 1, it schematically illustrates the process of a conventional method used by the scanner. As shown in FIG. 1, at first in the step 102, the scanner usually uses an N number of scanning lines to scan the document to be scanned step by step, in which the scanner start to scan from the n number of scanning lines out of the N number of scanning lines, in which the n quantity is equal to 1. And then, the process goes to the step 104, in which the optical sensing device including a plurality of pixels is under light exposure operation, so that each one of the pixels of the optical sensing device will produce the induced charges with respect to the n number of scanning lines. After then, the process goes to the step 106, in which the induced charges of each one of the pixels with respect to the n number of scanning lines are sequentially fetched out. And then, the process goes to the step 108, in which the induced charges of each one of the pixels with respect to the n number of scanning lines are processed to form a piece of the image, and the piece of the image is stored. After that, it is judged whether or not the quantity of n is equal to N, such as N=10000. If it is, then the process enters the step of 112, in which all of the pieces of the image are collected to form a full image with respect to the document to be scanned, and then the process goes to an end. If the judgment is negative, the process enters the step of 114, in which the quantity of n is added by 1, and the process goes back to the step of 102, and then the scanner starts to scan the next scanning line.

It should be noted that the number of the effective pixels in the optical sensing device, used for fetching the document to be scanned, is proportional to a width of the document to be scanned. In other words, the optical sensing device actually only needs to use a portion of the total pixels to fetch the image of the document to be scanned. For example, if the optical sensing device has 10000 pixels, and with respect to the document to be scanned by a size of A4, the actual number of the effective pixels being capable of fetching the image of the document to be scanned is only about 7200 pixels. The image fetched by the other of 2800 pixels is the extra part and not necessary. For this reason, it has been enough that the scanner actually only needs to fetch out and process the induced charges for those of effective pixels. However, practically, the induced charges for all of the pixels in the optical sensing device are necessary to be fetched out and process them. This causes that the scanning period becomes rather longer.

### SUMMARY OF THE INVENTION

It is therefore an objective of the present invention to provide a scanning method, which is able to reduce the scanning period. The scanning method is used by the optical sensing device, so as to distinguish optical sensing device into a front pixel region, an effective pixel region, and a post pixel region, according to the width of the document to be scanned. In this manner, it can save the time used to fetch out and process the induced charges belonging to the post pixel region, but also it can further save the time used to fetch out and process the induced charges belonging to the front pixel region. As a result, the objective to reduce the scanning period can be achieved.

In accordance with the foregoing and other objectives of the present invention, the invention provides a scanning method, which is able to reduce the scanning period. The scanning method can be used in a scanner with an optical sensing device. The scanner has an N number of scanning lines to scan a document to be scanned step by step, so that the optical sensing device can separately produce the induced charges for the pixels with respect to the scanning lines. At first, according to the width of the document to be scanned, a front pixel region, an effective pixel region for actually fetching the image of the document to be scanned, and a post pixel region are set for the optical sensing device. After that, the induced charges with respect to the nth scanning line are produced, in which the quantity of the parameter n is equal to or greater than 1. After then, the induced charges belonging to the front pixel region and the induced charges belonging to the effective pixel region with respect to the nth scanning line are fetched out. After then, the induced charges belonging to the post pixel region with respect to the nth scanning line are transferred to the front pixel region, so as to be added with the induced charges belonging to the front pixel region with respect to the (n+1)th scanning line. And then, the induced charges belonging to the effective pixel region with respect to the nth scanning line are processed into a piece of the image, which is then stored. After that, it is judged whether or quantity of the parameter n is equal to N. If it is, then all of the pieces of the image are collected to form a full image with respect to the document to be scanned. If it is not, then the parameter n is added by 1, and then the (n+1)^{th} scanning line is continuously scanned.

In accordance with the foregoing and other objectives of the present invention, the invention further provides another scanning method, which is able to reduce the scanning period. The scanning method can be used in a scanner with an optical sensing device. The scanner has a number of scanning lines to scan a document to be scanned step by step, so that the optical sensing device can separately produce the induced charges for the pixels with respect to each of the scanning lines. At first, according to the width of the document to be scanned, a front pixel region, an effective pixel region for actually fetching the image of the document to be scanned, and a post pixel region are set for the optical sensing device. After that, the induced charges with respect to each one of the scanning lines are sequentially produced. And then, the induced charges belonging to the front pixel region and the induced charges belonging to the effective pixel region with respect to each one of the scanning lines are sequentially fetched out. And then, the induced charges belonging to the post pixel region with respect to each one of the scanning lines are transferred to the front pixel region, so as to be added into the induced charges belonging to the front pixel region for the next scanning line with respect to each one of the scanning lines. The induced charges belonging to the effective pixel region with respect to the each one of the scanning lines are processed into a piece of the image. And then, the pieces of the image are collected to form a full image with respect to the document to be scanned.

In addition, the front pixel region and the post pixel region are located at two sides of the effective pixel region, as well as the front pixel region and the post pixel region have the same number of pixels. Also and, the optical sensing device is an optical charge coupled device (CCD).

### BRIEF DESCRIPTION OF DRAWINGS

The invention can be more fully understood by reading the following detailed description of the preferred embodiments, with reference made to the accompanying drawings, wherein:

FIG. 1 schematically illustrates the process of a conventional scanning method used by the scanner; and

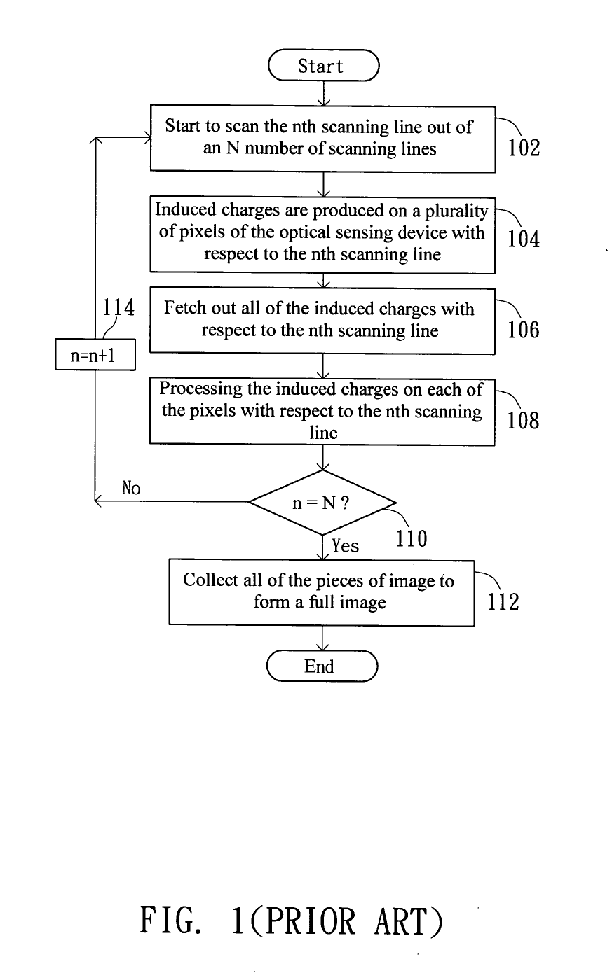

FIG. 2 schematically illustrates the process of a scanning method used by the scanner of the present invention.

### DETAILED DESCRIPTION OF PREFERRED EMBODIMENTS

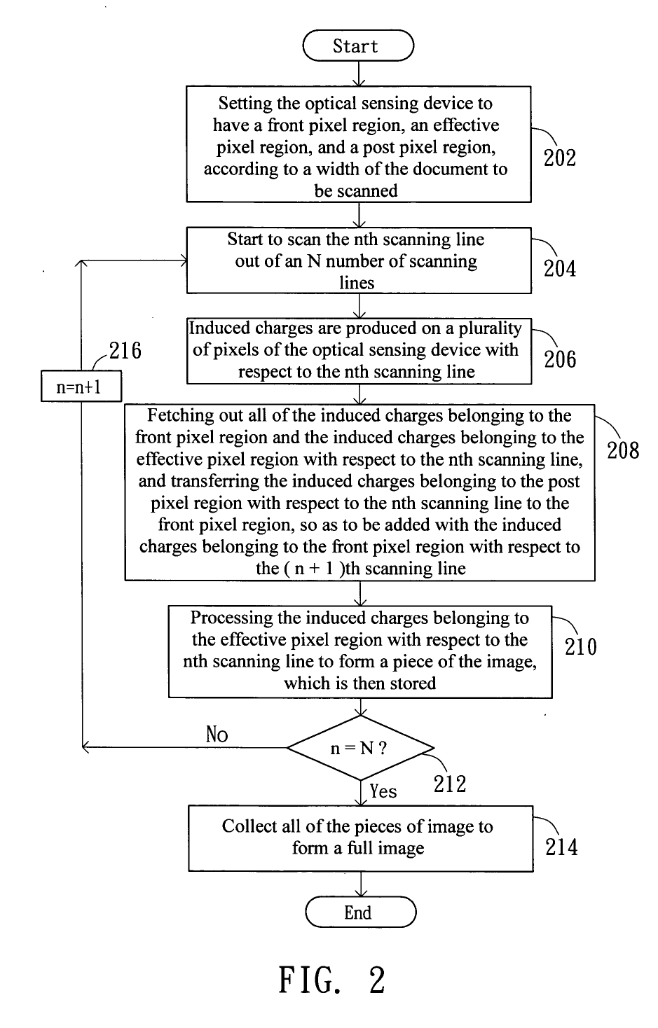

FIG. 2 schematically illustrates the process of a scanning method used by the scanner of the present invention. The scanning method of the present invention can be used in a scanner with an optical sensing device. The scanner has an N number of scanning lines to scan a document to be scanned step by step, so that a B number of pixels in the optical sensing device can separately produced with the induced charges with respect to each of the scanning lines. As shown in FIG. 2, in the step 202, in order to assure the number of the effective pixels, used for fetch the document to be scanned, the present invention is based on the width of the document to be scanned to set the optical sensing device into a front pixel region, an effective pixel region that is mainly used to fetch the image of the document to be scanned, and a post pixel region. Wherein, the front pixel region and the post pixel region are located at two sides of the effective pixel region. Also and, the front pixel region and the post pixel region have the same C number of pixels, and then the effective pixel region has the (B−2C ) number of pixels.

It is for sure that the present invention can scan the document to be scanned beforehand until the image of the document to be scanned can be fetched out. Then, a control unit of the scanner or a driving program, according to the image width of the document to be scanned, will determine the number of the pixels in the optical sensing device, which pixels are actually used to fetch the document to be scanned, and distinguish the spreading region of the effective pixels as the effective pixel region. The rest pixels will be uniformly distributed at the two sides of the effective pixel region and are separated as the front pixel region and the post pixel region.

For example, if B=10,000, then it indicates that the optical sensing device has 10,000 pixels. With respect to a document to be scanned having the size of A4, the optical sensing device actually has the 7200 number of effective pixels being actually used to fetch the image of the document to be scanned. This is the number of pixels for the effective pixel region. The image fetched by the rest 2800 pixels are superfluity and not necessary, and is total number of pixels of the front pixel region and the post pixel region. In other words, each of the front pixel region and the post pixel region has 1400 pixels, that is, C=1400.

An then, the process goes to the step 204, in which the scanner will start the scanning operation at the nth scanning line of the N number of scanning lines, in which n is equal to or greater than 1. After that, the process goes to the step 206, in which the light exposure action on the optical sensing device is performed, so that each of the pixels of the optical sensing device will produce the induced charges with respect to the nth scanning line. After that, the process goes to the step 208, in which the induced charges on the pixels of 1 to C belonging to the front pixel region as well as the induced charges on the pixels of (C+1) to (B−C ) belonging to the effective pixel region with respect to the nth scanning line are sequentially fetched out. Also and, the induced charges of the pixels of (B−C+1) to B belonging to the post pixel region with respect to the nth scanning line are transferred to the front pixel region at the pixels of 1 to C, so as to be added with the induced charges belonging to the front pixel region at the pixels of 1 to C with respect to the (n+1)th scanning line.

For example, the induced charges for the pixels of 1 to 14000 belonging to the front pixel region and the pixels of 1401 to 8600 belonging to the effective pixel region with respect to the nth scanning line are fetched out. And then, the induced charges for the pixels of 8601 to 10000 for the front pixel region with respect to the nth scanning line are transferred to the pixels of 1 to 14000 belonging to the front pixel region, and are used to be added with the induced charges for the pixels of 1 to 14000 belonging to the front pixel region with respect to the next (n+1)^{th} scanning line.

It should be noted that the present invention only fetched out the induced charges belonging to the front pixel region and the effective pixel region, and then the induced charges belonging to the post pixel region are transferred to the front pixel region, so as to be added with the induced charges belonging to the front pixel region with respect to the next scanning line. As a result, the present invention can save the time consumed for fetching the induced charges belonging to the post pixel region and processing the fetched induced charges.

After that, the process goes to the step 210, in which the induced charges belonging the effective pixel region with respect to the nth scanning line are processed to form a piece of image, and the piece of image is stored. Since the induced charges belonging to the front pixel region are not produced with respect to the document to be scanned, the present invention drops the induced charges belonging to the front pixel region and the previous superfluity induced charges belonging to the front pixel region. In other words, the present invention only processes the induced charges belonging to the effective pixel region into a piece of image. Therefore, the present invention can save the time consumed for processing the induced charges belonging to the front pixel region.

And then, the process goes to the step 212, in which it is judged whether or not the quantity of n is equal to N, such as N=1000. If it is, then the process goes to the step 214, in which all of the pieces of image are collected to form a full image with respect to the document to be scanned, and then the process goes to an end. If it is not, then the process goes to the step 216, in which the quantity of n is added with 1, and the process goes to the step 204. The scanner again starts to continuously scan the (n+1)^{th} scanning line.

As can be understood, the one skilled in the art knows that the technology of the present invention is not restricted to the foregoing descriptions. For example, the optical sensing device can be an optical charge coupled device (CCD). The present invention can also take a shield means to shield the front pixel region and the post pixel region. As a result, it causes the front pixel region and the post pixel region not to receive the light beam, so as to prevent an overflow of induced charges from occurring due to the induced charges belonging to the post pixel region having been transferred to the front pixel region. In addition, the present invention can also design a document holder on the scanning platform of the scanner, so as to help the user in auxiliary to assure that the document to be scanned is disposed at the center portion on the scanning platform, and then it can be aligned to the effective pixel region.

In conclusions, the foregoing embodiment of the present invention has disclosed a scanning method, in which the scanning period can be greatly reduced. The scanning method can distinguish optical sensing device into a front pixel region, an effective pixel region, and a post pixel region, according to the width of the document to be scanned. In this manner, it can save the time used to fetch out and process the induced charges belonging to the post pixel region, but also it can further save the time used to fetch out and process the induced charges belonging to the front pixel region. As a result, the objective to reduce the scanning period can be achieved.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A scanning method, suitable for use in a scanner having an optical sensing device, wherein the scanner scans a document to be scanned step by step by an N number of scanning lines, so that induced charges with respect to each of the scanning lines are produced on the optical sensing device, the scanning method comprising:
Setting the optical sensing device to have a front pixel region, an effective pixel region that is used for fetching an image of the document to be scanned, and a post pixel region, according to a width of the document to be scanned;
producing induced charges with respect to an nth scanning line, in which a quantity of n is equal to or greater than 1;
fetching out all of the induced charges belonging to the front pixel region and the induced charges belonging to the effective pixel region with respect to the nth scanning line, and transferring the induced charges belonging to the post pixel region with respect to the nth scanning line to the front pixel region, so as to be added with the induced charges belonging to the front pixel region with respect to the (n+1)^{th} scanning line;
processing the induced charges belonging to the effective pixel region with respect to the nth scanning line to form a piece of the image, which is then stored; and
judging whether or not the quantity of the parameter n is equal to N, wherein if it is, then all of the pieces of the image are collected to form a full image with respect to the document to be scanned, and if it is not, then the parameter n is added by 1, and then the (n+1)^{th} scanning line is continuously scanned.

2. The scanning method as recited in claim 1, wherein the front pixel region and the post pixel region are located at two sides of the effective pixel region, as well as the front pixel region and the post pixel region have the same number of pixels.

3. The scanning method as recited in claim 1, wherein the optical sensing device comprises an optical charge coupled device (CCD).

4. A scanning method, suitable for use in a scanner having an optical sensing device, wherein the scanner scans a document to be scanned step by step by an N number of scanning lines, so that induced charges with respect to each of the scanning lines are produced on a B number of pixels of the optical sensing device, the scanning method comprising:
setting the optical sensing device to have a front pixel region with a C number of pixels, an effective pixel region that has a (B−2C) number of pixels and is used for fetching an image of the document to be scanned, and a post pixel region with a C number of pixels, according to a width of the document to be scanned;
producing induced charges with respect to an nth scanning line, in which a quantity of n is equal to or greater than 1;
sequentially fetching out all of the induced charges at the pixels of 1 to C belonging to the front pixel region and the induced charges at the pixels of (C+1) to (B−C ) belonging to the effective pixel region with respect to the nth scanning line, and transferring the induced charges at the pixels of (B−C+1) to B belonging to the post pixel region with respect to the nth scanning line to the front pixel region at the pixels of 1 to C, so as to be added with the induced charges at the pixels of 1 to C belonging to the front pixel region with respect to the (n+1)^{th} scanning line;
processing the induced charges belonging to the effective pixel region with respect to the nth scanning line to form a piece of the image, which is then stored; and
judging whether or not the quantity of the parameter n is equal to N, wherein if it is, then all of the pieces of the image are collected to form a full image with respect to the document to be scanned, and if it is not, then the parameter n is added by 1, and then the (n+1)^{th} scanning line is continuously scanned.

5. The scanning method as recited in claim 4, wherein the front pixel region and the post pixel region are located at two sides of the effective pixel region, as well as the front pixel region and the post pixel region have the same number of pixels.

6. The scanning method as recited in claim 4, wherein the optical sensing device comprises an optical charge coupled device (CCD).

7. A scanning method, suitable for use in a scanner having an optical sensing device, wherein the scanner scans a document to be scanned step by step by a plurality of scanning lines, so that induced charges with respect to each of the scanning lines are produced on the optical sensing device, the scanning method comprising:
setting the optical sensing device to have a front pixel region, an effective pixel region that is used for fetching an image of the document to be scanned, and a post pixel region, according to a width of the document to be scanned;
sequentially fetching out all of the induced charges belonging to the front pixel region and the induced charges belonging to the effective pixel region with respect to each one of the scanning lines, and transferring the induced charges belonging to the post pixel region with respect to each one of the scanning lines to the front pixel region, so as to be added with the induced charges belonging to the front pixel region with respect to the next scanning line; and
sequentially processing the induced charges belonging to the effective pixel region with respect to each one of the scanning lines to form a piece of the image, and collecting all of the pieces of the image to form a full image with respect to the document to be scanned.

8. The scanning method as recited in claim 7, wherein the front pixel region and the post pixel region are located at two sides of the effective pixel region, as well as the front pixel region and the post pixel region have the same number of pixels.

9. The scanning method as recited in claim 7, wherein the optical sensing device comprises an optical charge coupled device (CCD).
